(19) United States
(12) Patent Application Publication
(10) Pub. No.: US 2019/0325901 A1
(43) Pub. Date: Oct. 24, 2019

(54) GRAMOPHONE WITH A TURNTABLE, LEVITATING ON A MAGNETIC CUSHION

(71) Applicant: Mag-Lev Audio D.O.O., Sempeter (SI)

(72) Inventor: Sebastijan Smrtnik, Vrhnika (SI)

(21) Appl. No.: 16/341,555

(22) PCT Filed: Oct. 9, 2017
(86) PCT No.: PCT/EP2017/075699

§ 371 Date: Apr. 12, 2019

(30) Foreign Application Priority Data
Oct. 12, 2016 (SI) P-201600253

(51) Int. Cl. G11B 3/60

(52) U.S. Cl. CPC G11B 3/60

(57) ABSTRACT

The design of the gramophone (100) for playing music recordings on vinyl records (50) which rotate on a levitating turntable (10) with the help of magnetic forces, substitutes all established versions of analogue gramophones, where the drive and rotation of the turntable are predominantly provided by an electric motor and mechanical elements. The technology of the turntable (10), rotating and levitating on magnetic forces, does not require changing the other elements of the analogue gramophone device, however, its advantage is that it reduces the unwanted vibrations of the turntable (10) and its unsteady rotation while playing music. In this way the accuracy and credibility of the sound readings is improved. Additionally, the need to push the turntable stylus (32) more strongly on the vinyl record (50) is reduced, otherwise required due to the possible skipping of the stylus (32). Thus the format of the sound recording in the groove of the vinyl record (50) is maintained for a longer period of time, as well as the sharpness of the turntable stylus (32). To ensure steady rotation, the excess inertia mass of the turntable (10) is no longer required. In addition to the benefits in sound processing, the new technology also upgrades the level of the visual experience when listening to audio artistic creations. The system of the levitating and rotating turntable can also be used for other purposes, such as to display products in showroom windows and similar.

### SUBJECT OF THE INVENTION

The subject of the invention is a gramophone or record player having a rotatable turntable to play music recordings from analogue sound carriers, i.e. vinyl records, where in comparison to the established technology the turntable is not hinged and driven by mechanical machine elements, however, it is levitating above the housing of the gramophone and it spins with the help of electromagnetic forces. The other components of the gramophone can remain substantively unchanged according to the existing established turntables, however, the shape and style can be adapted to the new image of the device. The technology of the levitating turntable, where the vinyl record is located, does not change the fundamental elements of the analogue gramophone device, which means that for its comprehensive realization other technical and commercially established parts of analogue turntables can be used. Besides the advantage in sound processing, the new technology upgrades the level of visual experience when listening to music, since the levitating and rotating turntable together with the sound carrier has a surreal and superlative effect on the listener, hence the whole experience of listening to music artistic creations is even greater.

### TECHNICAL ISSUE

Classic gramophones which may also be denoted as record player are used for the purpose of reproduction of sound, recorded into an analogue vinyl in the shape of a groove, which is engraved on both sides of the record, generating spiral patterns and running from the outside edge towards its geometric centre. Crudely, the gramophone consists of a housing with electric and navigation-switching elements, motor drive, turntable, movable tonearm and electromagnetic pickup with a stylus. The latter moves in all directions as it slides on the vinyl groove. Through vibrations in the attachment point, electromagnetic impulses are created, which are then appropriately amplified by the loudspeaker units, thus interpreting the sound experience to the listener.

The main characteristic of a good gramophone is that the vinyl record is rotated with an appropriate and steady speed without any unwanted accelerations, decelerations and with as little vibrations as possible.

The main reasons for the unsteady rotation of the vinyl with most classic gramophones are an unstable voltage, which drives the electric motor, and the variable friction of the belt transmission, which transmits the rotation from the driving axle of the motor to the powered axle of the turntable.

Unwanted vibrations can be created by the gramophone device itself due to the poor quality of the electrical and mechanical components. An even more common reason for vibrations is the surrounding space, hence vibrations occur for example due to walking on an unstable floor in the room with the gramophone, due to unwanted touches of the gramophone or the gramophone plinth during its operation, or due to sound vibrations caused by the strongly amplified music alone. Nowadays, the producers muffle the unwanted vibrations with various turntable suspension systems or with an appropriate choice of turntable suspension materials. The more prestigious versions of gramophones solve this problem with a very heavy turntable and also an oversized mass of the whole device, which leads to high costs of gramophone production as well as a high price of other music components, coinciding with such an expensive gramophone in style and quality.

A belt transmission is in practice most commonly used for the transmission of rotation from the driving axle of the electric motor to the powered axle of the turntable. The motor is usually located under the turntable outside its pivot and it transmits the kinetic rotational energy to the turntable with the help of a plastic belt which reduces disturbances in the low frequency range, since the belt absorbs most of the friction and disturbances, caused by the motor. A direct drive is also used and is enabled by contemporary stepping electric motors, however, these motors must be designed in such a way that they do not produce any low-frequency noise on the pickup.

The turntable tonearm's job is to hold the pickup with the stylus above the vinyl. The stylus follows the spiral shape of the groove which is engraved on the record. The tonearm must hold the pickup above the spiral groove as precisely as possible and at the same time with as little friction as possible, while slightly pushing it. The ideal tonearm would be weightless, and would require no force for travelling in the lateral direction according to the spiral track, and would at the same time be extremely rigid and without its own vibrations. Its vertical tracking angle on the spiral groove should be exactly the same throughout its full length, however, due to technological barriers and the high price this is in general not the case with the exception of top-quality devices.

The tangential tonearm is recognized as the best tonearm in the world. One of the best tangential tonearms is owned by a Slovenian producer Kuzma Air Line, since it ensures that the vertical tracking line of the magnetic pickup is the same at the beginning and end of the recording. Due to air suspension the tonearm is at all times rigid and does not produce vibrations, but it evenly tracks the spiral groove.

In general, there are two types of magnetic pickups at the end of the tonearm: with moving magnets (MM) and with a moving coil (MC). Both types function are based on electromagnetic induction. With both of them the turntable stylus is able to move in all directions and thereby it creates a weak magnetic field, resulting in a weak electric current. The difference between MM and MC pickups is in the core of the pickup: there, the MM pickup contains magnets and the MC pickup contains coils. The MM pickup produces a voltage of up to 5 mV, therefore it is suitable for basic turntable preamplifiers. The MC pickup has a lower impedance and produces only 0.2 mV, therefore it requires a more precise and complex turntable preamplifier to amplify the signal, and the result is a better dynamic in sound and more accurate readings of sound sequences in the low-frequency range. There are also pickups with a moving iron (MI), whose quality is closer to the MC pickups. Optical heads, which scan the groove shape on the surface of the vinyl record and then decode the sound via computer, have not experienced the commercial breakthrough and are rarely used.

A gramophone record (or a phonograph record, or simply a record) is an analogue sound carrier of a round-flat shape with an engraved spiral groove which starts on the peripheral side and ends in the centre of the record. The term LP (“long play”) record refers to records where the recording of the original sound can be listened to at 33 revolutions per minute (LP 33 rpm or 33⅓ rpm). The other markings 16 rpm, 45 rpm and 78 rpm refer to different speeds and do not have the “LP” marking. Before 1950 records were made of shellac, later they were mostly made of polyvinyl chloride (PVC), hence the name vinyl record or vinyl (source: Wikipedia—The Free Encyclopaedia).

The device according to the invention solves the following technical problems: how to ensure the rotating of the music medium, i.e. the analogue gramophone record, to be as steady and without vibrations as possible at a relatively low mass of the turntable, how to reduce the wear of the mechanical parts of the record coming into contact and the stylus to the lowest possible degree, and at the same time to improve the visual effect of the device which would raise this in a way outdated technology back to the level, interesting to a wider audience.

### SOLUTION TO A TECHNICAL PROBLEM

It is the object of the present invention to provide a gramophone (record player) that prevents vibration of the housing to be transmitted to the turntable.

The above object is solved by the claimed matter according to the independent claims.

Accordingly, there is provided a gramophone, including a turntable being adapted to support a sound recording carrier, preferably a vinyl record, a housing, a tonearm carrier, a tonearm, a magnetic pickup with a turntable stylus, wherein the gramophone further comprises: a first turntable-side permanent magnet, at least one first housing-side permanent magnet, and first electromagnetic correction coils, the electromagnetic correction coils being adapted to control a levitation of the turntable above the housing by means of electromagnetic forces, which are created by the turntable-side permanent magnet and by the housing-side permanent magnet, and second turntable-side permanent magnets and drive electromagnetic coils adapted to control a rotation of the turntable by means of electromagnetic forces, which are created by the second turntable-side permanent magnets.

Preferably, a gap between an upper surface of the housing and a lower surface of the turntable is in a range from 1 to 200 mm, preferably 30 to 50 mm, said gap defining the height of levitation in accordance to the created magnetic field strength.

Preferably, the turntable comprises a disc, preferably made of plastics, wherein the disc has in its geometric centre on its upper side a metal tip adapted to centre a sound recording carrier, wherein preferably a diameter of the disc is equal to or slightly greater than the diameter of a long play vinyl record, which is about 280 to 300 mm, especially 290 mm.

Preferably, the disc has a plurality of recesses or grooves, each recess or groove being adapted to house one of the second turntable-side permanent magnets.

Preferably, the recesses or grooves have a bottom being part of a lower surface of the disc, and an opening directed to the inside or to the upper surface of the disc, so that the second turntable-side permanent magnets are secured in the disc invisibly to a user.

Preferably, the second turntable-side permanent magnets are distributed at an outer rim of the disc in the shape of a ring, wherein the second turntable-side permanent magnets are equally distributed along a circumferential direction of the disc.

Preferably, a distance between two neighbouring second turntable-side permanent magnets is about 2 cm to 10 cm, preferably about 4 cm to 6 cm, wherein the number of second turntable-side permanent magnets is a multiple of the number of drive electromagnetic coils.

Preferably, the second turntable-side permanent magnets are disc-shaped having a diameter from 5 to 20 mm, preferably 8 to 12 mm, wherein the height of the second turntable-side permanent magnet is from 1 to 10 mm, preferably 3 to 5 mm.

Preferably, a second disc made of soft iron is rigidly secured to the upper surface of the disc and is recessed throughout its entire thickness into the disc, so that the second disc is not visible to a user.

Preferably, the thickness of the second disc ranges from 0.1 to 2.5 mm, preferably 0.3 to 0.7 mm, the outer diameter of the second disc is smaller than the diameter of the disc by 1 to 10 mm, preferably 2 to 4 mm, and wherein preferably the second disc has in its geometric centre a round hole with a diameter that allows the passage of the metal tip of disc.

Preferably, a vertical distance of the second disc to the first and second turntable-side permanent magnets is from 2 to 50 mm, preferably 5 to 15 mm.

Preferably, the turntable comprises a coating, made in the shape of a disc with an external diameter being the same as the diameter of the disc, said coating is removably arranged on the upper side of the disc, wherein preferably said coating is made of synthetic or natural materials, preferably jute or felt or rubber.

Preferably, the disc comprises at its lower side a plurality of reflection surfaces for the specular reflection of light, wherein the reflection surfaces are recessed in the lower surface of the disc.

Preferably, the reflection surfaces are evenly distributed along a ring shape, wherein preferably their number is equal to the number of the second turntable-side permanent magnets.

Preferably, the housing comprises a plurality of light sensors, preferably two light sensors, adapted to separate a difference of light reflection and to thus scan the rotational speed of the disc through the reflection of the reflection surfaces.

Preferably, the first turntable-side permanent magnet is mounted inside the disc and preferably is a permanent neodymium magnet, preferably in the shape of a uniform magnetic circular plate with its centre in the geometric centre of the disc, wherein preferably the inner diameter of the circular plate is in a range of 2 to 8 cm, preferably 3 to 5 cm, wherein preferably the cross-section area of the first turntable-side permanent magnet is about 100 mm², wherein preferably the first turntable-side permanent magnet is located within the thickness of the disc, so that it is thus mechanically secured and hidden from sight.

Preferably, the gramophone comprises a plurality of the first housing-side permanent magnets, which are arranged in a ring of preferably the same diameter as the diameter of the first turntable-side permanent magnet, wherein preferably the first housing-side permanent magnets are provided inside the housing, preferably just below its surface, wherein preferably the number of first housing-side permanent magnets is 1 to 50, preferably 4.

Preferably, the gramophone comprises a plurality of electromagnetic correction coils, preferably 4 electromagnetic correction coils, wherein the electromagnetic correction coils are evenly distributed within the ring of first housing-side permanent magnets.

Preferably, the gramophone further comprises a plurality of support feet adapted to mechanically support and deposit the turntable while the gramophone is in its resting position.

Preferably, on the housing of the gramophone four support feet are installed, wherein preferably each support foot has a circular cross-section and a conical shape in its upper part, so that the turntable is supported by the tips of these cones.

Preferably, the feet pass vertically through an upper plate of the housing through corresponding holes, preferably using a spindle mechanism and a servomotor, wherein the holes are evenly distributed along an imaginary circle with its centre in the axis, and the diameter of the imaginary circle is substantially the same as the mean diameter of a circular groove in the turntable.

Preferably, the feet in their lower inactive level are hidden in the housing to such an extent that their conical upper parts remain visible, wherein preferably the feet are adapted to be lifted evenly and synchronized up to a height which exceeds the height of the turntable by 1 to 10 mm, preferably 2 to 4 mm.

Preferably, the diameter of the feet is from 5 to 20 mm, preferably 8 to 12 mm, the height of the conically shaped upper part is from 1 to 10 mm, preferably 2 to 4 mm, wherein preferably the feet in their raised position rest with the conically shaped tip against the circular groove of the disc, the width of the circular groove being from 0.5 to 10 mm, preferably 1 to 3 mm less than the diameter of the feet cross-section.

Preferably, the gramophone further comprises a switch adapted to turn on and off the gramophone, wherein the a switch is preferably adapted to take three positions, first for switching off the device, secondly for turning on and rotating the turntable at 33.3 revolutions per minute, and thirdly for turning on and rotating the turntable at 45 revolutions per minute.

Preferably, the gramophone further comprises a system for ambient lighting, the system preferably having ring light which is recessed in the upper surface of the housing, preferably so deep that the edge surface of the ring light is level with the surface of the housing.

Preferably, the gramophone further comprises a control unit adapted to control levitation of and rotation of the turntable by controlling the power and direction of electric current to create according respective magnetic fields of the first electromagnetic correction coils and/or of the drive electromagnetic coils.

The invention is explained in detail with the description of the case with respect to the embodiment shown in the annexed drawings, which show the following:

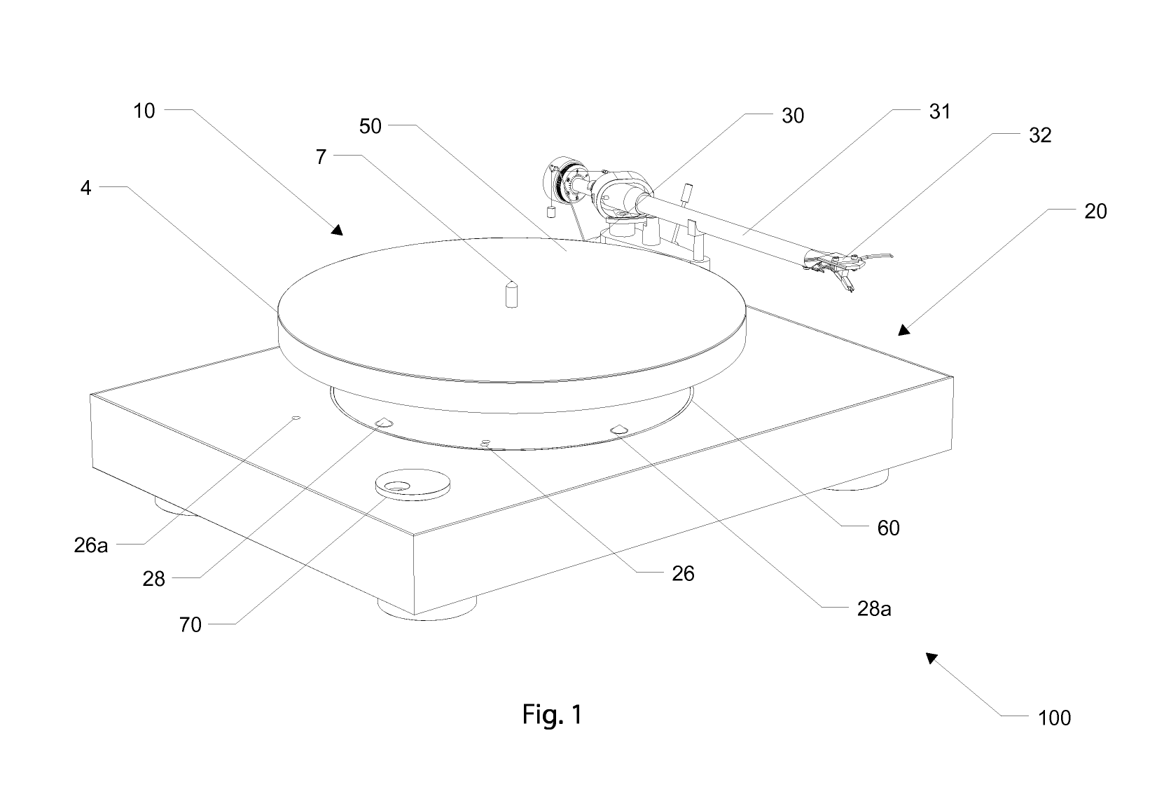

FIG. 1 An orthogonal projection of the entire gramophone device 100.

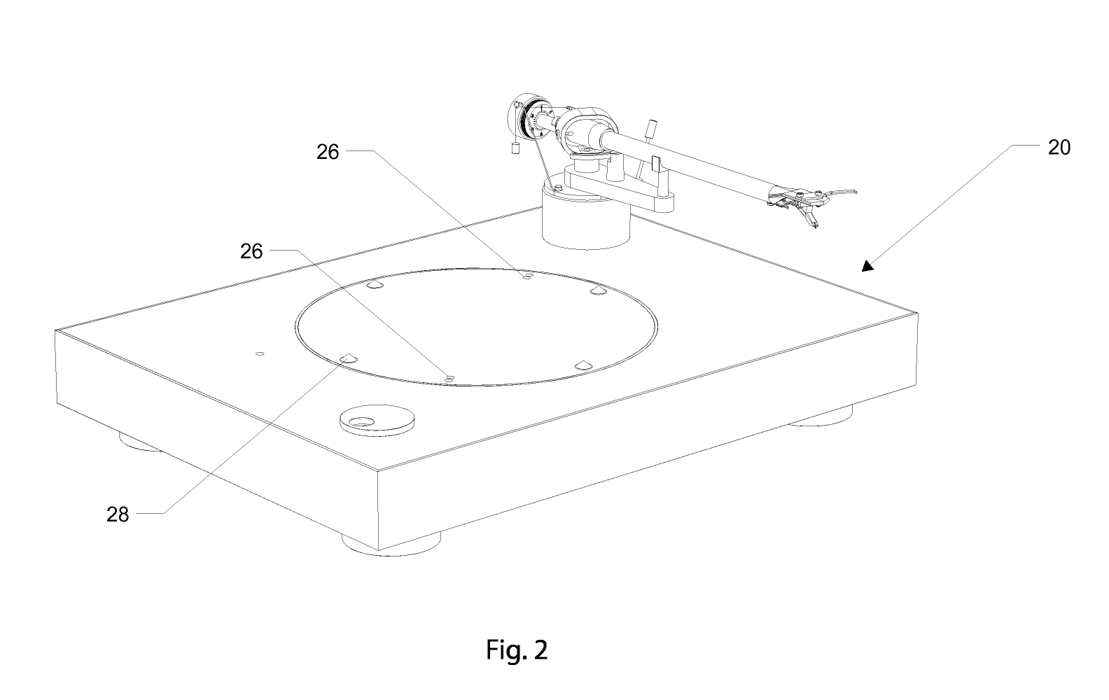

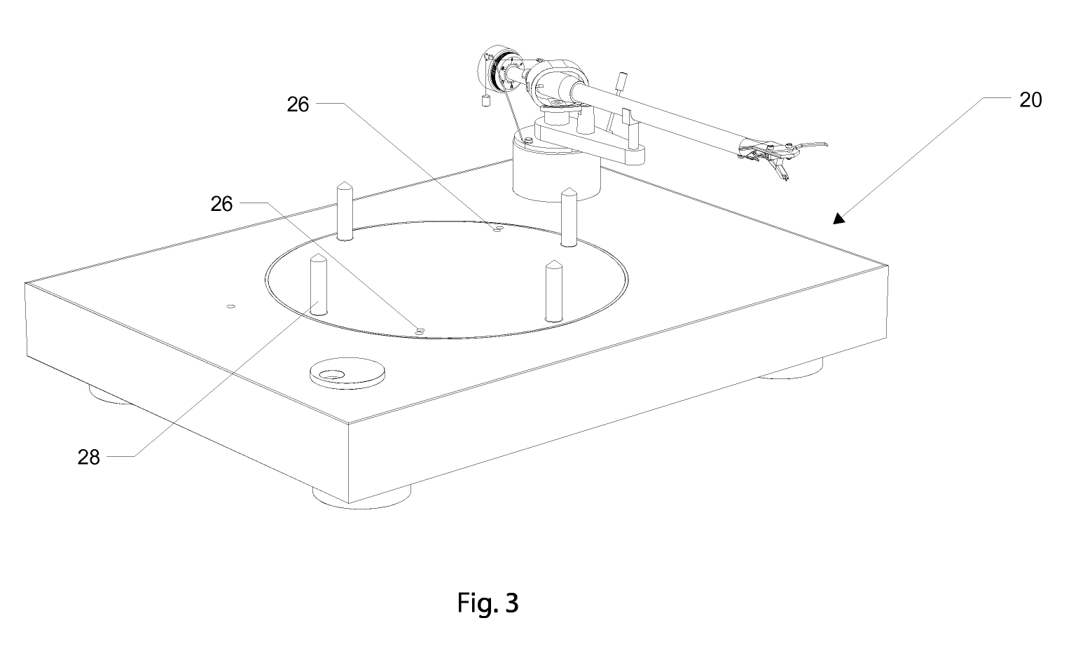

FIG. 2, 3 An orthogonal projection of the gramophone device 100 without the turntable 10, because directly under the turntable 10 on the device housing there are visible movable feet 28 and holes 28a, at one time in the lower inactive level and at other time in the upper active (support) level.

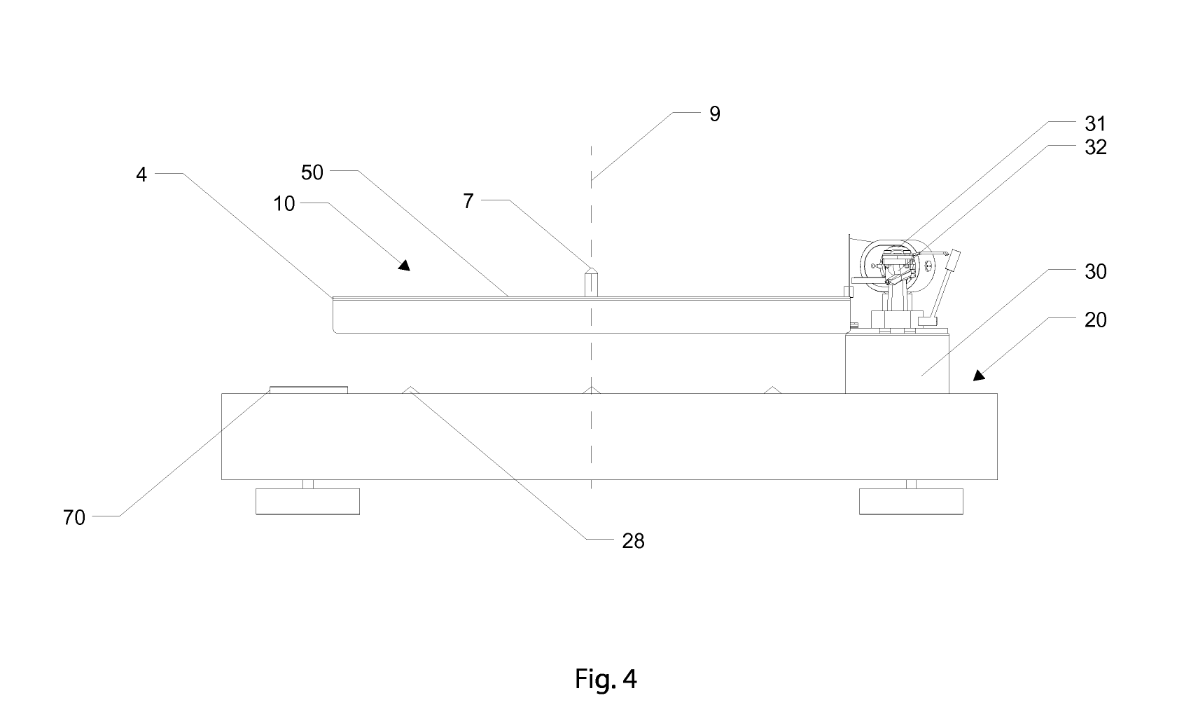

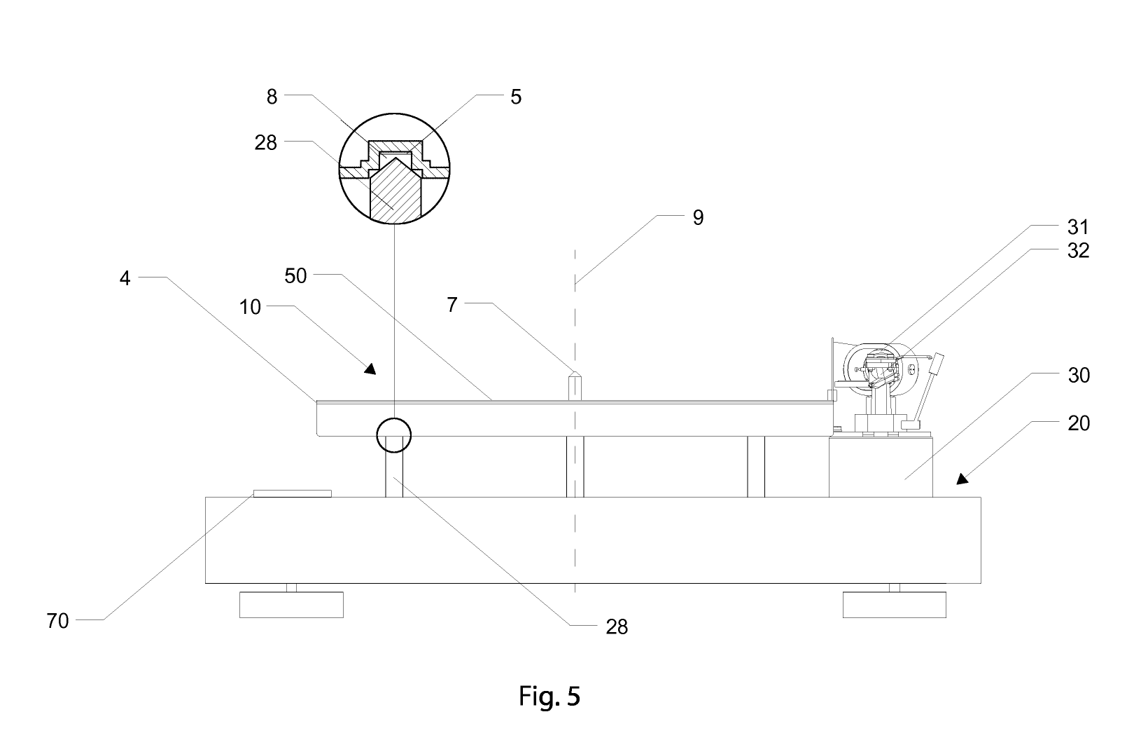

FIG. 4, 5 The elevation view of the gramophone device 100, first as the turntable 10 levitates above the magnetic cushion during operation, and secondly, as the turntable 10 is supported by the feet 28 during the sleep mode. In FIG. 5, a cross-section shows in detail how the feet 28 rest against the circular groove 8.

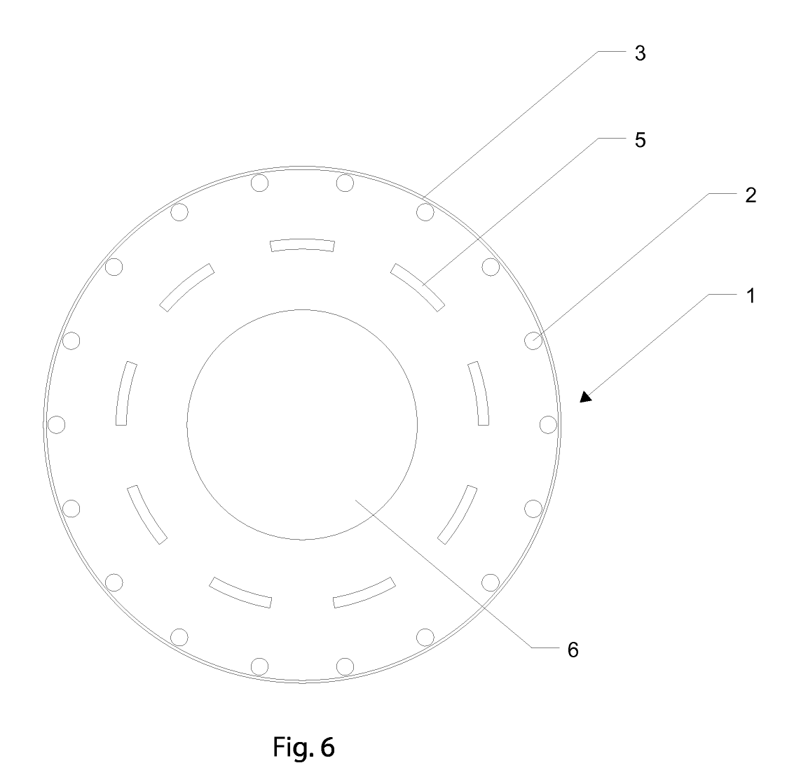

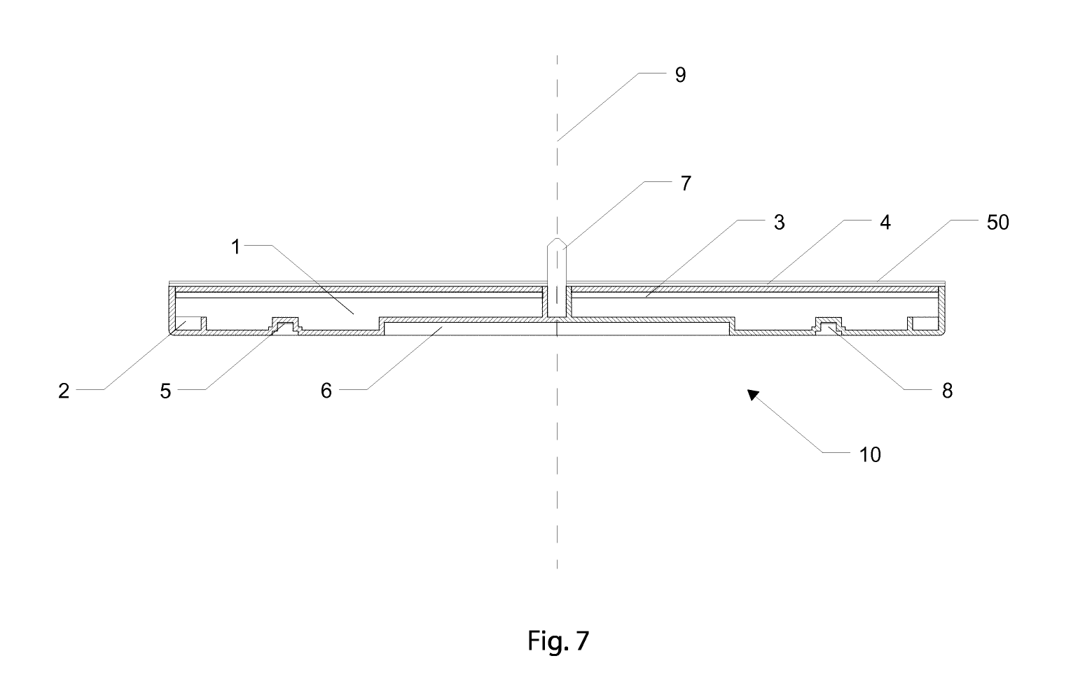

FIG. 6, 7 The layout schematic view of the turntable 10 schematically shows how the permanent magnets and other components as well as the corresponding cross-section are arranged inside.

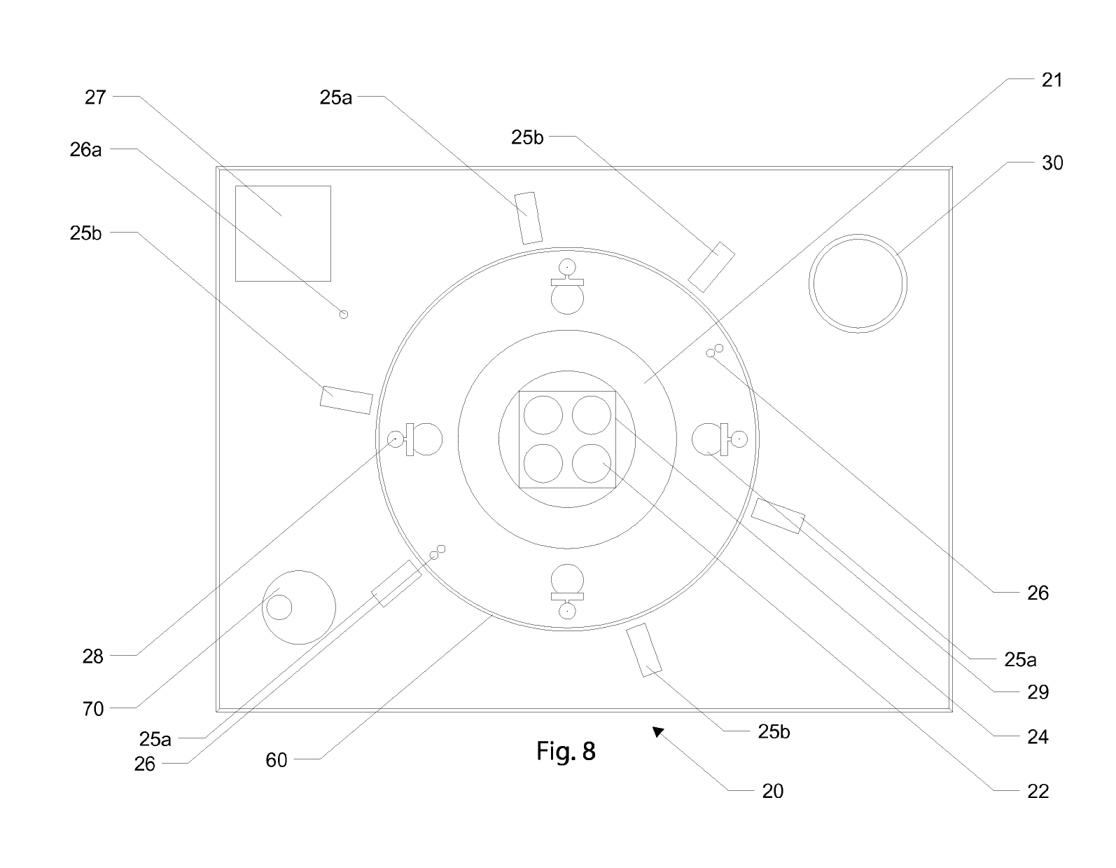

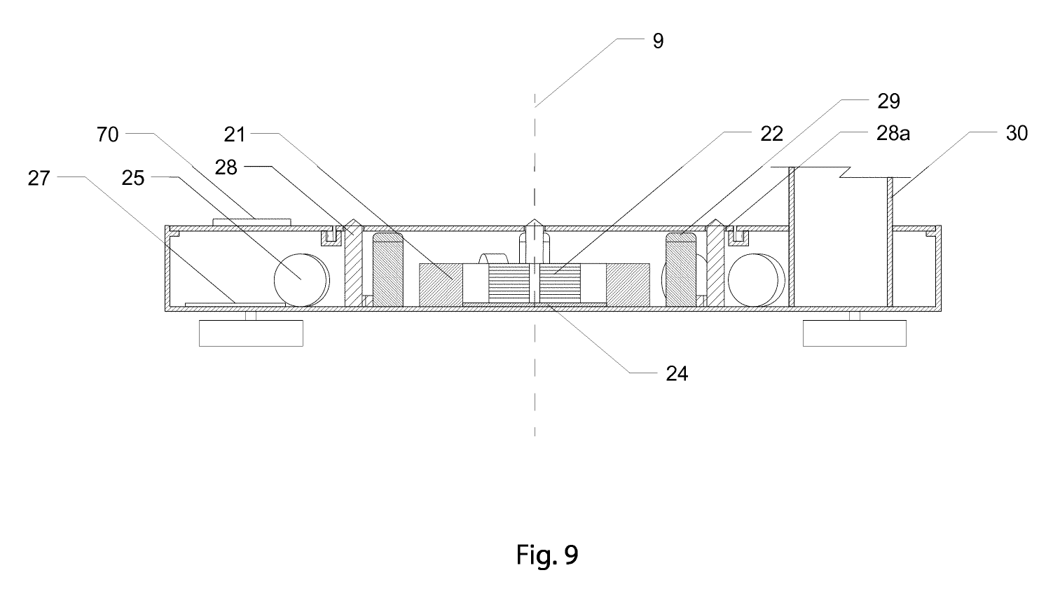

FIG. 8, 9 The layout schematic view of the turntable housing schematically shows how the permanent magnets, electromagnetic coils and servomotors as well as the corresponding cross-section are arranged inside.

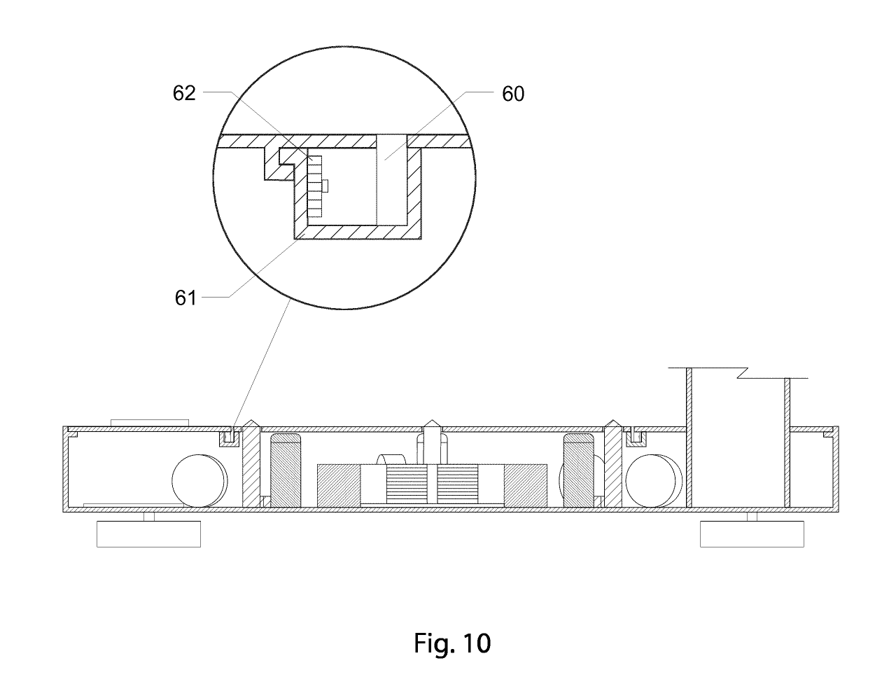

FIG. 10 A subset for the ambient lighting 60, 61, 62 of the gramophone device 100 is shown schematically.

In the following description reference is made to according figures showing the respective reference signs even if the respective figure(s) is not mentioned in any case.

The basic components of the turntable of the gramophone 100 according to the invention (being also denoted as device 100 in the following description) are as follows:

A turntable 10, which is comprises the following sub-elements (FIG. 6, 7): Plastic disc 1, in which the holes for the permanent magnets 2, 6 and the ring 3 are located. A ring of disc permanent neodymium magnets 2, which are distributed inside the disc 1 throughout its outer circle. Disc 3 (second disc), made of soft iron, is rigidly secured and recessed into the upper surface of the disc 1 and it has the same centre as the disc 1. Jute cover (felt) 4, which covers the upper surface of the disc 1. A light reflector 5 on the bottom surface of the disc 1 is intended to regulate the speed of the disc 1 and reflect light, preferably towards the two light sensors 26 (FIG. 8), which are placed underneath in the housing 20 of the device 100 at a distance of preferably within one quarter of the length of the circle with the centre in point 9. Permanent magnet 6, preferably in the form of a circular plate with a rectangular cross-section is responsible for the levitation of the disc 1 above the housing 20 of the device 100 during operation. A metal tip 7 for fixing and centring the vinyl records 50 to the disc 10. A circular groove 8, at the bottom of which the light reflectors 5 are installed (FIG. 5, 7). During resting position of the device 100, the support feet 28 rest against the outer edge of the circular groove. The rotation axis 9 of the disc 1 (FIG. 4, 5, 7, 9).

The housing 20 comprises of the following elements (FIG. 8, 9): Permanent neodymium magnets 21 create the magnetic field, which in combination with the magnet 6 inside the disc 1 enables the levitation of the turntable 10 above the housing 20 in the axis 9. The electromagnetic correction coils 22 are responsible for balancing and centring the turntable's 10 rotation, which would otherwise be thrown from the axis 9 by the magnetic field between the permanent magnets 6 and 21. A microcontroller 27 controls the stabilization and centring of the turntable 10. The drive electromagnetic coils 25 for rotating the turntable 10. Preferably two optical elements 26 to control the speed of the turntable's 10 rotation. An optical element 26a to control the height of the turntable 10. The microcontroller 27 to control the speed of rotation of the turntable 10. The support feet 28 with servomotors 29 are intended to mechanically support and place the turntable down 10 when the device 100 is in the resting position. The light ring 60 for ambient lighting the levitating turntable 10 with the circular carrier 61 and the LED strip 62, enabling multi-coloured lighting of different intensities. Switch 70 for turning the device 100 on and off, which can take three positions: Switching off the device 100, turning on and rotating the turntable 10 at 33.3 revolutions per minute, turning on and rotating the turntable 10 at 45 revolutions per minute. The turntable tonearm carrier 30, turntable tonearm 31 and the magnetic pickup with the turntable stylus 32. Protective dust cover (not shown). Carrier of the sound recording—vinyl record 50.

The technology of the turntable 10 which levitates on a magnetic cushion ensures that no vibrations, which result in shaking of the device housing 20 due to unwanted touches or due to shaking of its plinth or ground during operation, are transmitted to the medium with the sound recording 50, i.e. the vinyl record. A possible unwanted external vibrations which could be transmitted to the magnetic pickup 32 by the turntable tonearm 31, which remains classic and unchanged, and therefore connected to the device housing, is insignificant due to the low mass of the tonearm or its mass balanced tonearm mechanism.

The device 100 thus improves the accuracy and credibility of the sound readings. Additionally, the need to push the turntable stylus 32 on the vinyl record 50 with more force is reduced, but otherwise it is required in case of vibrations because it is possible for the stylus 32 to skip between the individual grooves of the sound recording. Therefore the mechanical wear of the recording in the groove of the vinyl record 50 as well as the wear of the turntable stylus 32 is reduced. To ensure a steady rotation, the inertia excess mass of the turntable 10 and the whole device 100 is no longer required, hence the production and transport costs are reduced, and the transport of the device in the user's space alone is simplified. The whole gramophone 100 gains a higher level of aesthetic value and thus strengthens the entertainment and artistic experience of listening to music.

The described technical problem is solved with a gramophone 100, whose essential characteristic is to ensure the levitation of the turntable 10 above the housing of the device 20 with the help of electromagnetic forces, created by permanent magnets 6 and 21 with the help of a correction electromagnetic coil 22, and at the same time the rotation of the turntable 10 with the help of electromagnetic forces, created by permanent magnets 2 in correlation with programme controlled drive electromagnetic coils 25.

The space between the upper surface of the housing 20 and the lower surface of the disc 1 determines the height of levitation. According to the created magnetic field strength and according to the weight of the turntable 10 the height of levitation can range between 1 and 200 mm, preferably 40 mm.

The turntable 10 consists of a disc 1 with a diameter equal or slightly bigger than the diameter of a “long play” vinyl record 50, i.e. 290 mm. The thickness of the turntable 10 is not essential for the invention and can vary between 8 and 100 mm, preferably 25 mm. The material of the disc is preferably plastic which is homogeneous, solid, at the same time of low specific weight, and it can be produced by jet moulding, pouring into moulds or it can be simply shaped and joined in some other way. In the geometric centre of the disc 1 there is a metal tip 7 for centring the vinyl record 50, which is of standard dimensions and shapes for the needs of centring and fixing the vinyl records and is therefore not the subject of the invention.

Inside the disc 1, grooves for the installation of permanent magnets 2, which enable the rotation of the disc 1, are deployed. The magnets 2 are preferably disc-shaped and are firmly secured in the disc 1. They are preferably invisible to the user, since their outside circular edge is moved from the outside circular edge of the disc 1 into its inner part between 0 and 20 mm, preferably 2 mm. A wreath of disc permanent neodymium magnets are deployed at the outer rim in the shape of a ring with a distance between them of 2 to 10 cm, preferably 5 cm, or precisely the distance required by the pitch circle in the ring diameter to achieve an equal distribution of permanent magnets 2, meaning the distance between them is the same, and at the same time the number of magnets must be a multiple of the number of electromagnetic coils 25. According to the polarization direction of the permanent magnets 2, they are turned in such a way that their magnetic forces are perpendicular to the disc 1, meaning every following magnet in the ring is depending on the direction of the magnetic force field orientation turned by 180 degrees, or depending on the version not turned, and that there is an even number of magnets in the ring. The diameter of the disk-shaped permanent magnets 2 is between 5 and 20 mm, preferably 10 mm, the height of the magnet disc is between 1 and 10 mm, preferably 4 mm.

Disc 3, made of soft iron, is rigidly secured to the upper surface of the disc 1 and is recessed into it throughout its entire thickness, so that the upper surface of the disc 1 remains even. It shares the geometrical centre 9 with the disc 1. The thickness of the iron disc 3 ranges between 0.1 and 2.5 mm, preferably 0.5 mm. The outer diameter of the disc 3 is smaller than the disc 1 diameter by 1 to 10 mm, preferably 3 mm, therefore when recessed into the disc 1 the edge is not visible and at the same time it is protected against corrosion. In its geometric centre, the iron disc 3 has a round hole with a diameter, allowing for the passage of a metal tip 7. The iron disc 3 is intended to prevent the penetration of the magnetic forces of the permanent magnets 2, 5 and 6 upwards, where the electromagnetic pickup 32 is located during operation. The vertical distance of the iron disc 3 and the permanent magnets 2 is between 2 and 50 mm, preferably 10 mm, since by increasing the distance between the iron and the permanent magnets, the efficiency of neutralizing the transition of the permanent magnets' magnetic field through iron is greater.

The cover 4, laid over the upper side of the disc 1, is removable. Its diameter is preferably the same as the diameter of the disc 1. The cover 4 is made of synthetic or natural materials, preferably jute or felt, or rubber and it provides better traction of the vinyl record 50 with the disc 1. Besides its anti-slip properties the cover must also be antistatic, soft enough and suitable for regular manual cleaning.

The surfaces for specular reflection of light 5 are mounted in the circular channel 8, which is recessed into the bottom surface of the disc 1 in depth of 1 mm to 15 mm, preferably 8 mm. Width of the circular channel 8 is The quantity is preferably equal to the number of permanent magnets 2. The material is not prescribed, however, with regard to its light reflectance it must be different enough from the rest of the lower surface of the disc 1, for the light sensor to be able to accurately separate the difference of the light reflection. One or more light sensors 26, preferably two, scan the rotation speed of the disc 1 through the reflection of the specular surfaces 5 and provide the process unit with this information 27, and thereby enable it to properly regulate the speed of changing the direction and strength of the electromagnetic field, produced by the electromagnetic coils 25 in the housing 20 of the device 100, whose magnetic forces cross the magnetic forces of the permanent magnets 2 in the disk 1 and thus create the required torque for acceleration, the maintaining of a constant speed and the deceleration of the turntable's 10 rotation.

The levitation of the turntable 10 with all the integrated components is enabled by a permanent neodymium magnet 6, preferably in the shape of a uniform magnetic circular plate with its centre in the geometric centre of the disc 1, where the rotation axis 9 also passes through. The inner diameter of the circular plate is between 2 and 8 cm, preferably 4 cm and the cross section of the magnet 6 is preferably 10×10 mm. This magnet is just like the magnets 2 rigidly mounted inside the disc 1. The magnet 6 is preferably located in the centre of the disc 1 thickness, and is thus mechanically secured and hidden from sight. Its magnetic forces travel in the direction, perpendicular to the surface of the disc 1, and the magnetic field reflects downwards, this is the direction in which the forces reflect from the permanent magnets 21, mounted in the housing 20 of the device 100 and whose magnetic forces are directed vertically upwards.

The levitation of the disc 1 with all the integrated components from 2 to 7 is enabled by a group of permanent neodymium magnets 21, which are arranged in a ring of the same diameter as the diameter of the magnet 6. The centre of the ring is located in the centre of the rotation axis 9. The magnets 21 are closed inside the housing 20 of the device 100, preferably just below its surface. The number of magnets can range from 1 to 50, preferably 4. In the version with four magnets, they are rectangular in shape, or in the shape of a circular sector of the same diameter as the ring, in which they are installed. In the version with four magnets, the length of the individual magnets is preferably 50 mm, and the rectangular cross-section preferably measures 10×10 mm. The magnets are arranged across the circle equally spaced from each other, they are rigidly fastened in the housing 20, and they are preferably hidden from sight. The magnetic forces of the permanent magnets 21 are directed vertically upwards, i.e. perpendicular to the surface of the disc 1 and in the opposite direction as the forces of the magnet 6. Thus, in-between a magnetic reflection is created.

The correction electromagnetic coils 22 are responsible for balancing and centring the position of the turntable 10, which would otherwise be thrown from the centre axis 9 by the magnetic field between the magnets 6 and 21. The coils 22 are evenly deployed throughout the ring with the centre in the axis 9, which is preferably of such a diameter that the inner edge of the coils 22 is separated from the outer edge of the permanent magnets 21 only by a thin electrical insulation layer. The coils 22 are laid horizontally, their forces travel vertically and all reflect upwards. By detecting changes in the electromagnetic field of the four coils 22, a microcontroller 24 determines the deviation of the turntable 10 from the axis 9 and on the basis of this data it increases the current power of those coils which are located in the position where the turntable 10 horizontally deviated, and thus the turntable 10 is returned back to the rotation axis 9.

Preferably, two triplets or groups of three drive electromagnetic coils 25 are evenly distributed throughout the horizontal ring at a distance of 120 degrees, with the centre in the axis 9, with the preferable minimum distance from the outer edge of the horizontal ring of correction coils 22. In order to identify the groups and their according coils, the coils are indicated with 25a and 25b, respectively, wherein the letters a and b are intended to indicated the respective group. Accordingly, each coil group has three coils 25a and 25b, respectively, which are arranged at an angle of 120 degrees among themselves in the respective group. Between each other, these two triplets or groups of coils 25 are angularly offset by 40 to 80 degrees, preferably by 50 and 70 degrees, respectively. This offset angle is measured between two neighbouring coils 25a, 25b of the respective (different) group. The preferred angle of 70 degrees can be seen between coils 25b (upper right side of the figure) and 25a (just beneath the middle of the figure) on the right side in FIG. 8. The preferred angle of 50 degree is illustrated between coils 25a (lower left side of the figure) and 25b (just above the middle of the figure) on the left side in FIG. 8. Unlike the correction coils 22, the drive coils 25 are set vertically and towards the geometric centre 9, and their magnetic forces travel in a horizontal direction tangential to the circle of rotation. In a specific unit of time all the magnetic forces of coils 25 are directed in the same direction. The required torque for rotation is ensured by the reflective attractive force between the magnetic forces of the permanent magnets 2 and the electromagnetic forces of the coils 25.

During operation, the drive coils 25 must constantly change the direction of the magnetic forces, in order to push the nearest magnet 2 away from the disc 1, and at the same time pull the next one closer. When the disc 1 rotates by a defined angle, the procedure is repeated, however, this time the direction of the electromagnetic forces changes, which means that the electromagnetic forces of the coils 25 constantly pulsate in various directions. In other words, the coils 25a, 25b are adapted to act in a pushing and pulling manner on the magnets 2, wherein when the group of coils 25a pushes the other group of coils 25b pulls and vice versa.

Where exactly a specific permanent magnet 2 is located during disc 1 rotation, in relation to the magnetic field of the coils 25, is preferably established by two light sensors 26 in the housing 20 through the specular reflection surfaces 5 in the disc 1. Information is then forwarded to the control unit 27, which, according to the required acceleration, maintenance of the speed or disc 1 braking, executes the relevant command on the power and direction of the electric current to create a magnetic field of coils 25.

There are so many programmes to maintain the speed of the turntable 10, as there are different requirements for the number of revolutions according to the types of vinyl records 50.

Unwanted vertical oscillations of the turntable 10, which occur during rotation on an uneven cushion of electromagnetic forces, are preferably cushioned by the same system of coils 25 and permanent magnets 2, which are intended to drive the turntable 10. With the correct determination of the time, power and direction for the magnetic field of the coils 25, there are no opposite effects of both functions between the magnetic forces. The vertical operation of the coil 25 in either direction shall be included, if necessary, and only then, when the coil 25 is located directly under the magnet 2, or more precisely 1 to 10 hundredths, preferably 2 hundredths of a second earlier, before both elements 2 and 25 are vertically covered and preferably the same amount of time after this transition. Coils 25, which have a predominantly horizontal impact on the requirements for the rotation of the turntable 10, thus operate vertically in the meantime between one and the other horizontal impulses if necessary. By dividing the time intervals of the same coil 25, two different functions are thus carried out in a chronological order, one is the drive function for the rotation of the turntable 10 and the other is the micro-stabilizing function for cushioning its vertical oscillations.

To take an example, if the distance between the permanent magnets 2, distributed on the outer circle of the disc 1, is 50 mm and thereby the time between the transition of two adjacent permanent magnets 2 above the coil 25 is e.g. 0.11 seconds, then preferably for the first 0.03 seconds of this interval, the coil 25 functions as a vertical stabilizer of the turntable 10 and the central part of the interval between the preferable 0.04 and 0.09 seconds is used for driving the turntable 10, the remaining time of this interval is again used for its stabilization. Detection of unwanted vertical fluctuations of the turntable is enabled by an optical element 26a, which is installed in the housing 20 and is located at a distance from the central axis 9, so as to illuminate the circle of the lower surface of the disc 1 near its outer diameter and thus measure the differences in distance of the disc 1 to the housing 20.

The element for determining the distance 26a is recessed in the housing 20 to such an extent that only its top part reaches the surface of the upper part of the housing 20. The element 26a is preferably composed of an optical sensor for determining the distance. Through a microcontroller 27 the optical sensor forwards the command for the required power and direction of the electric current in the electromagnetic coils 25. With the appropriate change of power and/or direction of the electromagnetic field in the for this provided time interval of the turntable 10 rotation, the electromagnetic coils then correct or annul the turntable's vertical oscillation.

The purpose of the support feet 28 with the corresponding servomotors 29 is to support and place down the turntable 10 while the device 100 is in the resting position. The magnetic field between the permanent magnets 6 and 21 is also present when the device is switched off, however, the system for stabilizing and centring 22 and 24 is turned off then. In this way, when switching off the system, the turntable 10 could be thrown from the axis 9, which could lead to the failure of the device and music medium, and the normal restart would also be disabled.

Because of this, there are four support feet 28 installed on the housing 20 of the gramophone 100. The support feet are preferably of a circular cross section and conical in shape in the upper part. The feet 28 pass through the upper plate of the housing 20 through the corresponding holes 28a, preferably using a spindle mechanism. Lifting feet with servomotors are a standard product and are not part of the invention. Holes 28a are evenly distributed throughout the imaginary circle with its centre in the axis 9. The diameter of the imaginary circle with the layout of the holes 28a and thereby the feet 28 in the housing 20 is the same as the mean diameter of the circular groove 8 in the turntable 10.

The diameter of the feet 28 is between 5 and 20 mm, preferably 10 mm, the height of their conically shaped tip is between 1 and 10 mm, preferably 3 mm. The feet 28 in their raised position with the conically shaped tip rest against the circular groove 8 of the disc 1, the width of which is from 0.5 to 10 mm, preferably mm less than the diameter of the feet 28, anyhow the diameter must be of such a size that the tip of the feet 28 cone can in no way touch the light reflector 5, which lies at the bottom of the groove 8. There is a slope on the two outer edges of the circular groove 8. The angle of this slope is preferably the same as the angle of the feet 28 cone. In this way, resting the turntable 10 against the feet 28 does not cause wear and the deformation of the contact surfaces, and at the same time the construction allows the maximum centring of the turntable 10 in the axis 9, while the device 100 is in the resting position. Thereby, a successful restart is also provided.

While inactive, the feet 28 are hidden in the housing 20, so only their conically shaped tops can be seen. In this way, the holes 28a are closed, which prevents dust from entering the housing 20, and at the same time the monolithic aesthetic image of the housing 20 is minimally disrupted. Using servomotors 29, the feet 28 rise from the housing 20 vertically synchronized up to a height which exceeds the height of the turntable's 10 levitation on a magnetic cushion. Before playing music, first the electromagnetic mechanism (22, 24) for the control of the rotation centering is turned on, then the servomotors 29 pull the feet 28 in the housing 20 through the corresponding holes 28a. After playing the last track on the vinyl record 50, or just before switching off the device 100, the servomotors 29 lift the feet 28 into the upright position, thereby mechanically supporting the turntable 10 and thus preventing the turntable from falling when the control electromagnetic mechanism for rotation centring (22, 24) is deactivated. The feet 28 lift to such an extent that in the upright position the disc 1 is lifted by 1 to 20 mm, preferably 3 mm above the levitation level on the magnetic cushion. During resting position or while the device 100 is switched off, the feet assume the entire weight of the turntable 10 and the vinyl record 50.

The turntable 10 can also be supported in a different way with the emphasis that during the resting position the turntable 10 is provided with a stable mechanical support in at least three positions, and that the mechanism is aesthetically sustainable and as hidden as much as possible while playing music.

When the device 100 is turned on, the stabilizing magnetic field of the coils 22 is automatically activated. When the music carrier 50 is set correctly and the tonearm 31 is activated, the feet 28 are automatically folded in the housing 20, and then the system for electromagnetically driving the turntable 10 is activated.

The ring light 60 provides ambient lighting of the device during operation. The ring is recessed into the upper surface of the housing 20, preferably deep enough so that the edge surface of the ring is level with the surface of the housing. The cross-section of the ring is preferably rectangular in shape, the thickness of the ring tape is between 1 and 30 mm, preferably 2 mm, and the width of the tape is between 5 and 40 mm, preferably 11 mm. The internal diameter of the ring 60 is between 100 and 350 mm, preferably 230 mm, and it is centred in the axis 9. The ring light 60 is made of a light permeable material. Inside the housing 20, the ring 60 is fixed on a circular carrier 61, which is preferably secured on the inner side of the upper surface of the housing 20. The diameter of the carrier 61 is preferably 30 mm larger than the diameter of the ring 60. On its inner side, there is a LED strip 62, which glows towards the centre axis 9. Most of the light is intercepted by the ring light 60, which transmits it in a scattered shape vertically upwards to the surface of the housing 20 and then further to the turntable 10. Thus, the gap between the housing of the device 20 and the levitating turntable 10 is additionally visually emphasized. The device 100 alone provides for the intense and light colour. A classic remote controller of the LED strip (not shown) can also be used for this.

The device 100 is universal and suitable for playing music of all known types and sizes of analogue sound carriers in the form of a vinyl record 50. The basic function of the gramophone device 100 is to play music. At the same time the device also offers a very intense level of visual experience.

In addition to being useful in the context of turntables, the system of levitation and rotation of the turntable is also suitable for various other devices (not shown), since due to its special visual experience it attracts the attention of the observers. For example, the turntable, rotating and levitating on magnetic forces, is suitable to display products in showroom windows and similar. In this case, the system for controlling the speed of rotation must allow for adjusting different, especially lower speeds for the observer to be able to see the product, displayed on the turntable, from all sides. The levitating tables and housings, made for this purpose, can also be of bigger or smaller layouts and load capacities than the turntable 10, in accordance with their intended purpose and application. In these cases, the device can also be designed in such way that the housing cannot even be seen, since it is hidden underneath the display window. Thus, the housing can be aesthetically less perfected, however, the visual effect of levitation can be even more emphasized.

It is understandable that the design of the device may be in terms of detail in shaping and connecting the basic components, also slightly different than the design described above, however, the main characteristics and features of the invention remain unchanged.

It is understandable that an expert in this field, based on the knowledge of the invention, can also design slightly different cases than the one described above, without thereby circumventing the basic characteristics of the invention, as defined in the following patent claims:

1. A gramophone, including a turntable being adapted to support a sound recording carrier, preferably a vinyl record, a housing, a tonearm carrier, a tonearm, and a magnetic pickup with a turntable stylus, wherein the gramophone further comprises:
a first turntable-side permanent magnet, at least one first housing-side permanent magnet, and first electromagnetic correction coils, the electromagnetic correction coils being adapted to control a levitation of the turntable above the housing by means of electromagnetic forces, which are created by the turntable-side permanent magnet and by the housing-side permanent magnet, and
second turntable-side permanent magnets and drive electromagnetic coils adapted to control a rotation of the turntable by means of electromagnetic forces, which are created by the second turntable-side permanent magnets.

2. The gramophone according to claim 1, wherein a gap between an upper surface of the housing and a lower surface of the turntable is in a range from 1 to 200 mm, preferably 30 to 50 mm, said gap defining the height of levitation in accordance to the created magnetic field strength.

3. The gramophone according to claim 1, wherein the turntable comprises a disc preferably made of plastics, wherein the disc has in its geometric centre on its upper side a metal tip adapted to centre a sound recording carrier, wherein preferably a diameter of the disc is equal to or slightly greater than the diameter of a long play vinyl record, which is about 280 to 300, especially 290 mm.

4. The gramophone according to claim 3, wherein the disc has a plurality of recesses or grooves, each recess or groove being adapted to house one of the second turntable-side permanent magnets.

5. The gramophone according to claim 4, wherein the recesses or grooves have a bottom being part of a lower surface of the disc, and an opening directed to the inside or to the upper surface of the disc, so that the second turntable-side permanent magnets are secured in the disc invisibly to a user.

6. The gramophone according to claim 3, wherein the second turntable-side permanent magnets are distributed at an outer rim of the disc in the shape of a ring, wherein the second turntable-side permanent magnets are equally distributed along a circumferential direction of the disc.

7. The gramophone according to claim 6, wherein a distance between two neighbouring second turntable-side permanent magnets is about 2 cm to 10 cm, preferably about 4 cm to
6 cm, wherein the number of second turntable-side permanent magnets is a multiple of the number of drive electromagnetic coils.

8. The gramophone according to claim 1, wherein a the second turntable-side permanent magnets are disc-shaped having a diameter from 5 to 20 mm, preferably 8 to 12 mm, wherein the height of the second turntable-side permanent magnet is between 1 and 10 mm, preferably 3 to 5 mm.

9. The gramophone according to claim 3, wherein a second disc made of soft iron is rigidly secured to the upper surface of the disc and is recessed throughout its entire thickness into the disc, so that the second disc is not visible to a user.

10. The gramophone according to claim 9, wherein the thickness of the second disc ranges from 0.1 to 2.5 mm, preferably 0.3 to 0.7 mm, the outer diameter of the second disc is smaller than the diameter of the disc by 1 to 10 mm, preferably 2 to 4 mm, and wherein preferably the second disc has in its geometric centre a round hole with a diameter that allows the passage of the metal tip of disc.

11. The gramophone according to claim 9, wherein a vertical distance of the second disc to the first and second turntable-side permanent magnets is from 2 to 50 mm, preferably 5 to 15 mm.

12. The gramophone according to claim 3, wherein the turntable comprises a coating, made in the shape of a disc with an external diameter being the same as the diameter of the disc, said coating is removably arranged on the upper side of the disc, wherein preferably said coating is made of synthetic or natural materials, preferably jute or felt or rubber.

13. The gramophone according to claim 3, wherein the disc comprises at its lower side a plurality of reflection surfaces for the specular reflection of light, wherein the reflection surfaces are recessed in the lower surface of the disc

14. The gramophone according to claim 13, wherein the reflection surfaces are evenly distributed along a ring shape, wherein preferably their number is equal to the number of the second turntable-side permanent magnets.

15. The gramophone according to claim 13, wherein the housing comprises a plurality of light sensors, preferably two light sensors, adapted to separate a difference of light reflection and to thus scan the rotational speed of the disc through the reflection of the reflection surfaces.

16. The gramophone according to claim 3, wherein the first turntable-side permanent magnet is mounted inside the disc and preferably is a permanent neodymium magnet, preferably in the shape of a uniform magnetic circular plate with its centre in the geometric centre of the disc, wherein preferably the inner diameter of the circular plate is in a range of 2 to 8 cm, preferably 3 to 5 cm, wherein preferably the cross-section area of the first turntable-side permanent magnet is about 100 mm², wherein
preferably the first turntable-side permanent magnet is located within the thickness of the disc, so that it is thus mechanically secured and hidden from sight.

17. The gramophone according to claim 1, wherein it comprises a plurality of the first housing-side permanent magnets, which are arranged in a ring of preferably the same diameter as the diameter of the first turntable-side permanent magnet, wherein preferably the first housing-side permanent magnets are provided inside the
housing, preferably just below its surface, wherein preferably the number of first housing-side permanent magnets is 1 to 50, preferably 4.

18. The gramophone according to claim 17, wherein it comprises a plurality of
electromagnetic correction coils, preferably 4 electromagnetic correction coils, wherein the electromagnetic correction coils are evenly distributed within the ring of first housing-side permanent magnets.

19. The gramophone according to claim 1, wherein two times three drive electromagnetic coils are distributed across the horizontal ring in the distance of 120 angular degrees, with the centre in the axis, wherein these two triplets of coils are between each other angularly offset by 40 to 80 degrees, preferably by 50 and 70 degrees, respectively.

20. The gramophone according to claim 1, wherein it further comprises a plurality of support adapted to mechanically support and deposit the turntable while the gramophone- is in its resting position.

21. The gramophone according to claim 20, wherein on the housing of the gramophone four support feet are installed, wherein preferably each support foot has a circular cross-section and a conical shape in its upper part, so the turntable is supported by the tips of these cones.

22. The gramophone according to claim 21, wherein the feet pass vertically through an upper plate of the housing through corresponding holes, preferably using a spindle mechanism and a servomotor, wherein the holes are evenly distributed along an imaginary circle with its centre in the axis, and the diameter of the imaginary circle is substantially the same as the mean diameter of a circular groove in the turntable.

23. The gramophone according to claim 21, wherein the feet in their lower inactive level are hidden in the housing to such an extent that their conical upper parts remain visible, wherein preferably the feet are adapted to be lifted evenly and synchronized up to a height which exceeds the height of the turntable by 1 to 10 mm, preferably 2 to 4 mm.

24. The gramophone according to claims 21, wherein the diameter of the feet is from 5 to 20 mm, preferably 8 to 12 mm, the height of the conically shaped upper part is from 1 to 10mm, preferably 2 to 4 mm, wherein preferably the feet in their raised position rest with the conically shaped tip against the circular groove of the disc, the width of the circular groove being from 0.5 to 10 mm, preferably 1 to 3 mm less than the diameter of the feet cross-section.

25. The gramophone according to claim 1, wherein the gramophone further comprises a switch adapted to turn on and off the gramophone, wherein the a switch is preferably adapted to take three positions, first for switching off the device, secondly for turning on and rotating the turntable at 33.3 revolutions per minute, and thirdly for turning on and rotating the turntable at 45 revolutions per minute.

26. The gramophone according to claim 1, wherein it further comprises a system for ambient lighting, the system preferably having ring light which is recessed in the upper surface of the housing, preferably so deep that the edge surface of the ring light is level with the surface of the housing.

27. The gramophone according to claim 1, further comprising a control unit adapted to control levitation of and rotation of the turntable by controlling the power and direction of electric current to create according respective magnetic fields of the first electromagnetic correction coils and/or of the drive electromagnetic coils.
